(19) United States
(12) Patent Application Publication
(10) Pub. No.: US 2015/0360413 A1
(43) Pub. Date: Dec. 17, 2015

(54) System and Method of Forming Machined Surface Finish On Polycarbonate Material

(71) Applicant: Northern Engraving Corporation, Sparta, WI (US)

(72) Inventors: Kevin E. Crary, La Crosse, WI (US); Kenneth R. Anderson, Melrose, WI (US)

(73) Assignee: Northern Engraving Corporation, Sparta, WI (US)

(21) Appl. No.: 14/737,894

(22) Filed: Jun. 12, 2015

Related U.S. Application Data
(60) Provisional application No. 62/011,497, filed on Jun. 12, 2014.

(51) Int. Cl. B29C 65/02; B44F 9/10; B29C 35/08; B29C 33/42; B29C 41/22

(52) U.S. Cl. CPC B29C 65/02; B29C 33/42; B29C 41/22; B29C 35/0805; B44F 9/10; B29C 2033/0005

(57) ABSTRACT

An exemplary system for manufacturing a decorated polycarbonate sheet can include a mold, which has a surface and a three-dimensional pattern formed on the surface, such that the three-dimensional pattern resembles a machined metal surface. A substrate can be configured to contact a curable photopolymer, such that the curable photopolymer forms a curable layup disposed between the substrate and the mold. A light source can be configured to cure the curable layup so as to form a cured layup. The mold can be configured to be separated from the cured layup, and the cured layup can have a decorative surface texture corresponding with the three-dimensional pattern, such that the decorative surface finish mirrors the three-dimensional pattern resembling the machined metal surface.

### CROSS REFERENCE TO RELATED APPLICATION

This application claims priority to U.S. Provisional Application Ser. No. 62/011,497, filed on Jun. 12, 2014, the specification of which is incorporated herein by reference.

### TECHNICAL FIELD

The disclosure relates generally to a system and method of forming parts having a decorative surface texture, and more particularly to a system and method of forming a machined surface finish on polycarbonate sheets.

### BACKGROUND

Automobiles include decorative trim pieces, which can be made of various materials using corresponding manufacturing processes. As one example, a decorative trim piece can be an injection molded component having smooth, non-textured surfaces and thus be somewhat inexpensive to manufacture. Other exemplary decorative trim pieces can be made of metal having machined surface finishes, which can be more expensive to manufacture as compared to the injection molded trim pieces. The metal trim pieces can have a matte surface finish, a brush metal surface finish or be otherwise machined to provide a surface with a visually aesthetic appearance.

Automobile manufacturers continuously research processes to build visually aesthetic vehicles in a cost effective manner. It would therefore be desirable to provide a system and method of manufacturing visually aesthetic plastic trim pieces, which are less expensive and easier to manufacture as compared to systems and methods used to manufacture metal trim pieces.

### SUMMARY OF THE DISCLOSURE

One exemplary system for manufacturing a decorated polycarbonate sheet can include a mold, which has a surface and a three-dimensional pattern formed on the surface, such that the three-dimensional pattern resembles a machined metal surface. The system can further include a substrate configured to contact a curable photopolymer, such that the curable photopolymer forms a curable layup or curable fiber-reinforced layer of resin disposed between the substrate and the mold. A light source can be configured to cure the curable layup so as to form a cured layup, and the mold can be configured to be separated from the cured layup. The cured layup can have a decorative surface texture corresponding with the three-dimensional pattern, such that the decorative surface finish mirrors the three-dimensional pattern resembling the machined metal surface.

An exemplary method for manufacturing a decorated polycarbonate sheet can include providing a mold, which has a surface and a three-dimensional pattern formed on the surface, such that the three-dimensional pattern resembles a machined metal surface. The method can further include applying a curable photopolymer onto the three-dimensional pattern. A substrate can be placed into contact with the curable photopolymer, such that the curable photopolymer forms a curable layup between the substrate and the mold. The curable layup can be cured to form a cured layup, and the mold can be separated from the cured layup. The cured layup can include a decorative surface texture corresponding with the three-dimensional pattern of the mold, such that the decorative surface texture resembles a machined metal surface.

### BRIEF DESCRIPTION OF THE DRAWINGS

Referring now to the drawings, exemplary illustrations are shown in detail. Although the drawings represent examples, the drawings are not necessarily to scale and certain features may be exaggerated to better illustrate and explain an innovative aspect of an illustrative example. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1A is a schematic view an exemplary system for manufacturing a decorated polycarbonate sheet, illustrating the system performing initial steps to provide a curable layup disposed between a substrate and a mold;

FIG. 1B is a schematic view of the system of FIG. 1B, illustrating the system performing steps to cure the curable layup and provide a decorated cured product;

FIG. 2A is a schematic view of another exemplary system, which includes a transparent mold having a three-dimensional pattern configured to form a decorative surface texture on the polycarbonate sheet that resembles a machined metal surface;

FIG. 2B is a schematic view of the system of FIG. 2A, illustrating a curable photopolymer being applied to the mold;

FIG. 2C is a schematic view of the system of FIG. 2B, illustrating the system including a substrate being placed onto the curable photopolymer to provide a curable layup between the substrate and the mold;

FIG. 2D is a schematic view of the system of FIG. 2C, illustrating the system including a roller mechanism applied to the substrate to remove at least a portion of air trapped within the curable layup;

FIG. 2E is a schematic view of the system of FIG. 2D, illustrating the system having a light source configured to expose the curable layup to light so as to provide a cured polycarbonate sheet;

FIG. 2F is a schematic view of the system of FIG. 2A, illustrating the mold being configured to separate from the cured polycarbonate sheet;

FIG. 3 is a perspective view of one non-limiting example of the mold of FIGS. 1A and 1B;

FIG. 4 is an enlarged perspective view of an exemplary cured polycarbonate sheet having a dome formed therein by a supplemental manufacturing process;

FIG. 5A is an enlarged view of a surface of the exemplary mold of FIGS. 1A and 1B, as taken by a scanning electron microscope and illustrating a three-dimensional pattern;

FIG. 5B is an enlarged view of a surface of the exemplary cured polycarbonate sheet of FIG. 1B, as taken by a scanning electron microscope and illustrating the cured polycarbonate sheet having a decorative surface texture corresponding with the three-dimensional pattern of the mold shown in FIG. 5A;

FIG. 6A is an enlarged view of a surface of another exemplary mold, as taken by a scanning electron microscope and illustrating a three-dimensional pattern;

FIG. 6B is an enlarged view of a surface of another exemplary polycarbonate sheet having a decorative surface texture corresponding with the three-dimensional pattern of the mold shown in FIG. 6A; and

FIG. 7 is a flow chart for a method of manufacturing a decorated polycarbonate sheet.

### DETAILED DESCRIPTION

An exemplary system and method for manufacturing a decorated polycarbonate sheet can be used to produce plastic components having surface texture patterns, which resemble the surface texture of machined metal components. As one example, the exemplary system and method can be used to produce vehicle trim pieces, which are made of polycarbonate and have a surface texture pattern of overlapping swirls or concentric rings that appear to correspond with a milling process for machining aluminum. The system and method can be used to produce other components, which are made of any suitable plastic material and have other surface texture patterns.

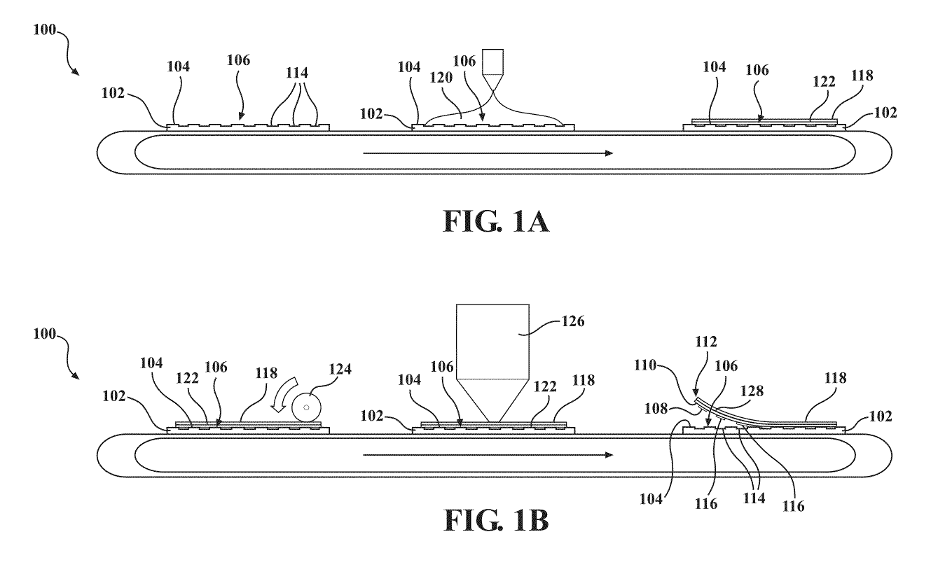

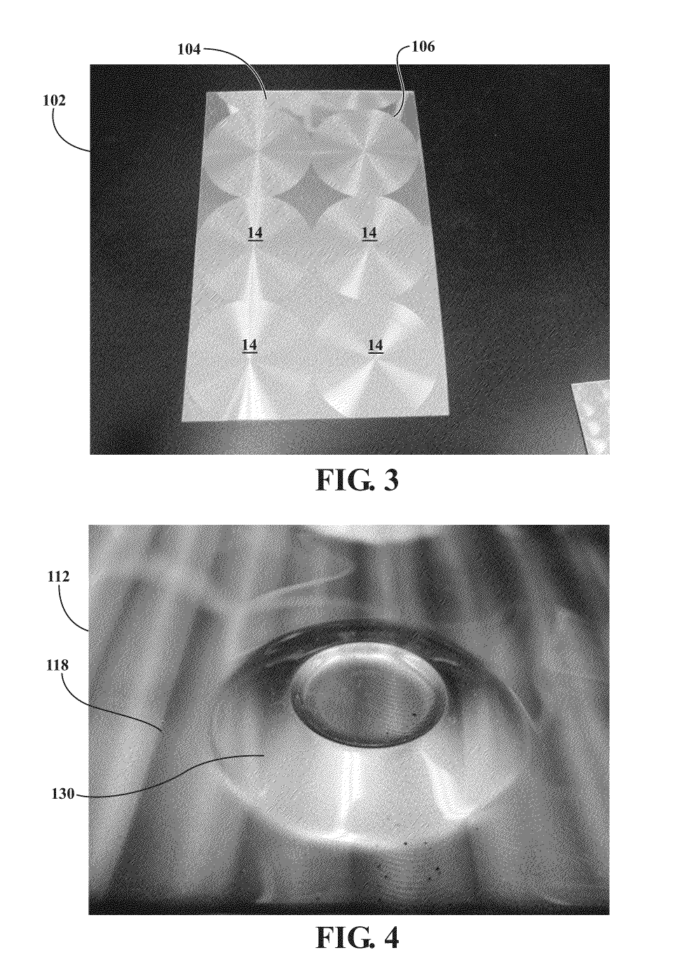

FIGS. 1A and 1B illustrate one non-limiting example of a system 100 performing progressive steps to manufacture a decorated polycarbonate sheet. The system 100 includes a mold 102, which has a surface 104 and a three-dimensional pattern 106 that is formed on the surface 104. The three-dimensional pattern 106 can be configured to form a decorative surface texture 108 on an exposed surface 110 of a cured product 112, such that the decorative surface texture 108 resembles a machined metal surface. In one non-limiting example, the decorative surface texture 108 resembles a surface of metal component that has been machined in a milling process. However, the decorative surface texture can instead resemble surfaces of metal components that have been machined by other processes. As best shown in FIG. 3, the three-dimensional pattern 106 of the mold 102 can include a plurality of concentric grooves or swirls 114 formed into the surface 104 of the mold 102, such that the swirls are arranged adjacent to one another and in columns along the surface 104 of the mold 102. In this respect, when a curable photopolymer is dispensed onto the three-dimensional pattern 106, the decorative surface texture 108 can be formed, such that it includes a plurality of swirls 118 similarly arranged adjacent to one another and in columns thus mirroring the swirls 114 of the mold 102. The depth of the swirls 118 can range from 0.1 μm to 3 μm. For this reason, the decorative surface texture 108 of the cured product 112 can be configured to reflect light in directions that are similar to those reflected by the surface texture of a machined metal component. Of course, the decorative surface texture can have non-circular grooves including peaks, valleys or other configurations, which can resemble a matte finish, brushed metal finish or other suitable decorative surface textures.

The mold 102 can be a metal sheet, such as nickel, copper, aluminum, stainless steel, alloys thereof or other suitable materials. As another example, the mold can be made of a plastic material configured to be used multiple times without significantly degrading the decoration imparted by the mold. In this example, the mold is made of an opaque material such that light does not transmit through the same.

Referring to FIG. 1A, the system 100 can further include a substrate 118 configured to contact a curable photopolymer 120, such that the curable photopolymer 120 forms a curable layup 122 between the substrate 118 and the mold 102. The substrate 118 can generally form a support layer of the final product. The substrate 118 may be made of any suitable material that has the desired strength, thickness and mechanical properties required of the final product. In this example, the substrate can be made of glass or a transparent cured polymeric material, such as a polycarbonate sheet or another transparent material. The substrate 118 may have any thickness that provides a useful end product, which has a thickness in the range of from about 0.005 inches to about 0.250 inches. It should be understood that he substrate can be a polycarbonate sheet having a thickness that permits a three-dimensional shape, such as a dome, to be formed in the substrate by applying heat and/or pressure to the substrate in a supplemental manufacturing process (See FIG. 4).

Referring to FIG. 1B, the system 100 can further include a roller mechanism 124 configured to manipulate or otherwise apply a force to the substrate 118, so as to compress the curable layup 122 between the substrate 118 and the mold 102, thus removing at least a portion of air trapped in the curable layup before compression.

Referring to FIG. 1B, the system 100 can further include a light source 126 configured to expose the curable layup 122 to light, thus providing a cured layup 128. In this example, the light source 126 is disposed on a side of the transparent substrate 118, which is opposite to the curable layup 122. The light source 126 can be configured to emit light having any suitable wavelength for a period of time that cures the layup. In one example, the light source 126 is configured to emit ultraviolet light. As yet another example, the light source can be configured to emit light having only the specific wavelength range necessary to cure the layup.

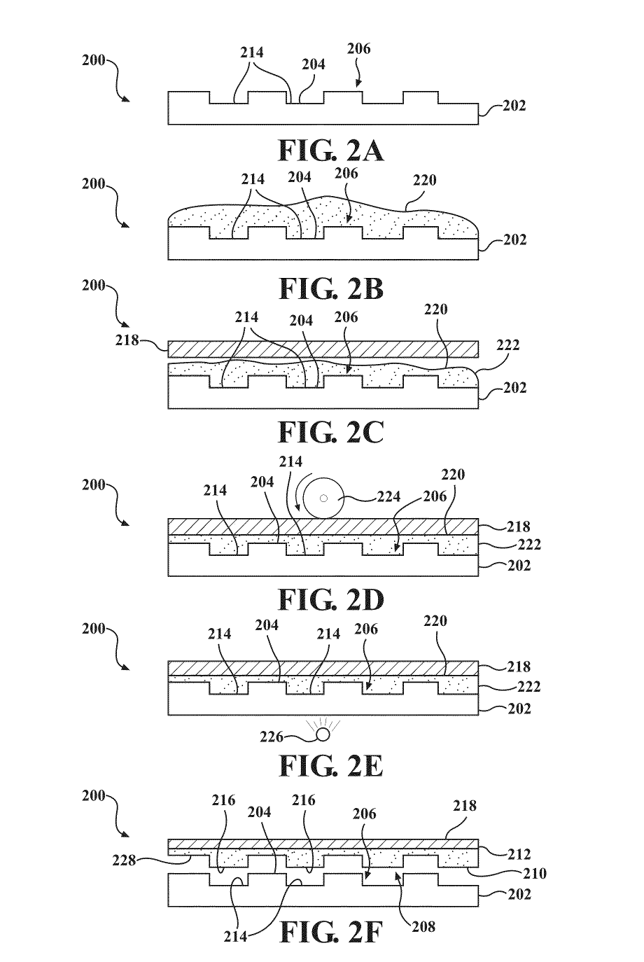

Referring to FIGS. 2A through 2F, another exemplary system 200 is substantially similar to the system 100 of FIGS. 1A and 1B, and thus includes similar components identified by corresponding reference numerals in the 200 series. For instance, the system 100 of FIGS. 1A and 1B includes the substrate 118 and the mold 102, and the system 200 of FIGS. 2A through 2F include a substrate 218 and a mold 202. However, the substrate 218 in this example is not transparent, and the mold 202 in this example is not opaque. Rather, the substrate 218 is opaque, and the mold 202 is transparent. More specifically, the substrate 218 can be a metal sheet or a rigid plastic material that is opaque to light at the wavelength necessary to cure curable layup. The metal sheet can be made of aluminum, copper, stainless, steel, nickel, zinc or other suitable materials. Furthermore, the mold 202 can be made of transparent or semi-transparent material configured to transmit light at the wavelength necessary to cure the curable layup 222. The mold 202 can therefore be transparent or semi-transparent glass or plastic. Examples of plastic materials can include hard plastics, such as polycarbonates, acrylics, polyesters, polyethylenes, polypropylenes and nylons. Also, in this example, the light source 226 is disposed on a side of the transparent mold 202 opposite to the curable layup 222, such that the light source 226 is configured to emit light through the mold 202 to the curable layup 222. Still another exemplary system can include a mold and a substrate, which are both made of a material that is transparent to light having a wavelength configured to cure the curable layup, such that the curable layup is cured by directing the light through at least one of the mold and the substrate and at the photopolymer.

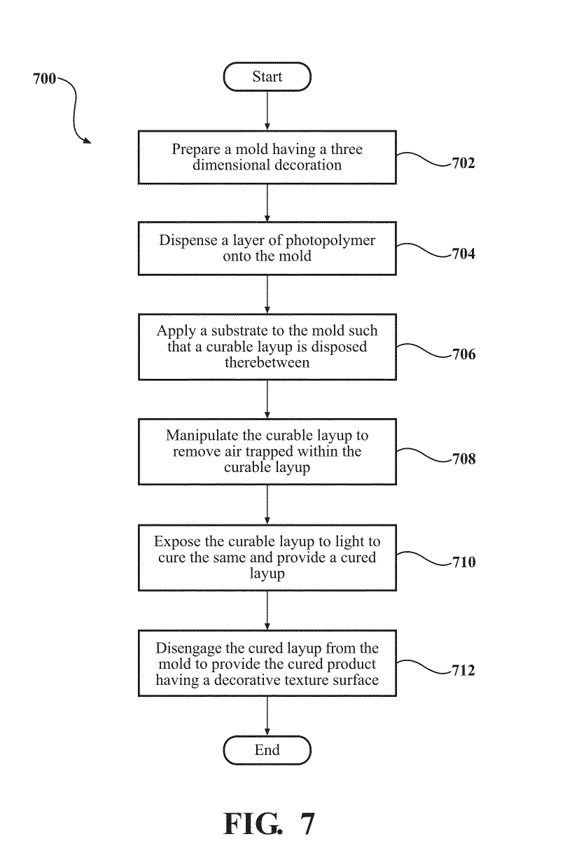

Referring to FIG. 7, an exemplary method 700 of operating the system 100 of FIGS. 1A and 1B is provided. At step 702, the method begins with providing the mold 102. This step can be accomplished by machining a metal sheet. For instance, an aluminum sheet can have a surface that is machined by a milling process to form a plurality of swirls or concentric grooves in the surface of the sheet, thus providing the three-dimensional pattern of the mold 102. Of course, this step can be accomplished by machining non-metal sheets so as to include any suitable surface texture.

A step 704, a layer of a photopolymer 120 is dispensed onto the mold 102 such that the curable photopolymer 120 contacts the surface 104 of the mold 102 having the three-dimensional pattern 106. The photopolymer is a polymer that changes its properties when exposed to light, often in the ultraviolet or visible region of the electromagnetic spectrum. These changes can include hardening of the photopolymer material as a result of cross-linking in response to the photopolymer being exposed to light. The photopolymer can include a mixture of monomers, oligomers, and photoinitiators that conform into a hardened polymeric material via curing initiated by exposure to light, such as ultraviolet light. Other non-limiting examples of photopolymers can be based upon oligomers of epoxides, urethanes, polyethers, or polyesters. The photopolymer material may be supplied in an uncured or partially cured form, and the photopolymer has sufficient viscosity to conform to the features of the decoration 106 on the surface 104 of the mold 102. Thus, the photopolymer material can be supplied in liquid form or it can be supplied as a sheet that is subsequently heated to reduce the viscosity of the photopolymer and allow the photopolymer to flow, such that the photopolymer contacts the surface of the mold.

At step 706, the transparent substrate 118 is applied to the mold 102 such that the layer of photopolymer 120 is disposed between the mold 102 and the substrate 118 to form a curable layup 122 therebetween. The substrate 118 will generally form the support layer of the final product.

At step 708, the curable layup 122 can be manipulated to remove at least a portion of air trapped between the substrate and the curable layup 122. In particular, the roller mechanism 124 as shown in FIG. 1B can apply pressure to the curable layup 122 by contacting and moving over the substrate 118. Any other manipulation methods that are capable of removing air trapped within a viscous material sandwiched between two material layers may be used, including sonic manipulation, placing the curable layup between two plates and moving the plates toward one another, subjecting the curable layup to a vacuum, or manipulation using jets or sheets of air or water or combinations thereof.

At step 710, the curable layup 122 can be cured to provide the cured layup 128. In particular, the curable layup 122 can be exposed to light at the required range of wavelengths for a period of time sufficient to cure the photopolymer to harden the same and form the cured layup 128. The step of curing should be understood to mean at least partially curing, or preferably as well as completely curing.

At step 712, the mold 102 is disengaged from the cured layup 128 to form the cured product 112 or composite, which includes the substrate 118 having a generally smooth planar surface and the cured photopolymer material having the surface imparted with the decorative surface texture 108 formed from the three-dimensional pattern 106 of the mold 102. Non-limiting examples of the thickness of the cured photopolymer material can be in the range from 0.00025 inches to 0.25 inches, or in the range from 0.00010 inches to 0.10 inches. However, the thickness can be higher or lower than these ranges.

Referring to FIG. 4, another exemplary system and method can include an additional step that forms a dome 130 in the cured product 112. In particular, the cured product can be subsequently molded by placing the cured polycarbonate sheets into a mold and subjecting those sheets to pressures and/or temperatures sufficient to cause the cured product to soften and deform so as to take a shape imparted by the mold, such as the dome 130. However, the supplemental process can be used to form any suitable shape in the cured product. Other exemplary systems and methods may not include the step of forming the cured product, such that the cured product retains a planar or sheet configuration and can thus be applied to another object as is.

In one example, the decorative surface texture 108 of the cured product 112 can be attached to another object (not shown), such that the decorative surface texture 108 can be viewed through the transparent substrate 118. Moreover, dyes and inks can be applied to a portion of or to the entire surface of one or both sides of the cured product. These dyes and ink can be used to enhance the visibility of the three-dimensional decorated surface decorations, provide three-dimensional effects or exhibit words, letters, logos or designs. For example, chrome ink can be applied to either surface of cured product 112 by a screen printing process. The dyes or inks can be applied before, after or during the step of curing the curable layup.

The exemplary system and method provide a cured product having a three-dimensional decorated surface that is not smooth. This surface can includes peaks, valleys and other features that are imparted by the mold. The resulting decoration of the cured product has a surface texture that is similar to the surface texture of a machined metal component. To facilitate this, the decorative surface texture 108 can have features as small as 3 μm and even as small as 1 μm.

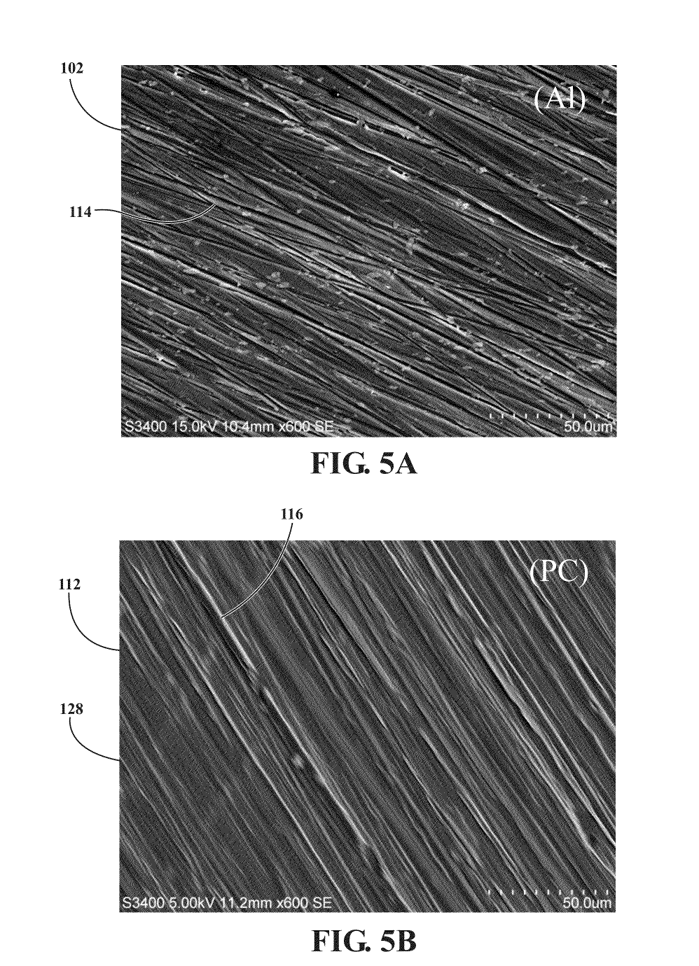

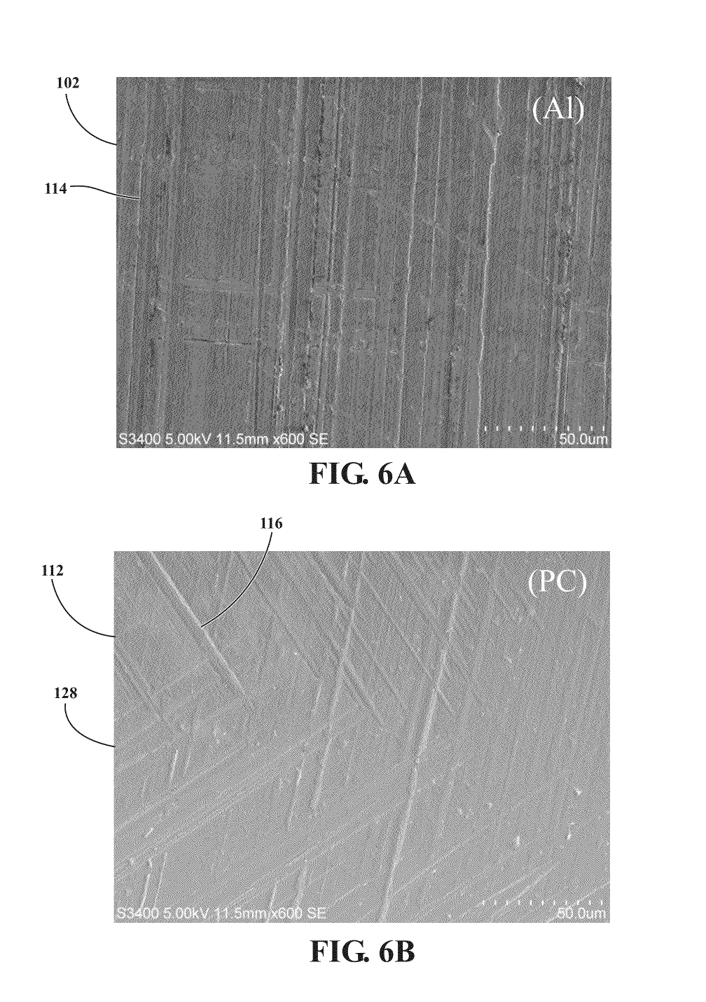

Referring to FIGS. 5A and 6A, exemplary aluminum molds 102 can have surfaces 104 and a three-dimensional pattern 106 formed therein that is configured to form a corresponding decorative surface texture 108 in the cured product 112. The surface 104 of the mold 102 can have features that range from 0.34 μm to 3 μm or greater, or even from 0.5 μm to 3 μm. For instance, the surface 104 of the aluminum mold 102 can include a pattern of linear or non-linear grooves, and each groove can have a peak to valley depth of 0.34 μm (FIGS. 5B and 6B). As shown in FIGS. 5B and 6B, the features of the decorative surface texture 108 on the cured product 112, which correspond with the three-dimensional pattern of the mold 102, can range from about 1 μm to about 3 μm. However, one or both of the three-dimensional pattern and the decorative surface texture can have features that are larger or smaller than these ranges.

In addition to the molding methods discussed above, the cured products can include additional decorative features or they can be further modified before they are used. For example, a thin material sheet including a decoration, decal, colored layer or the like can be located between the substrate and the photopolymer to provide a background for the decorated surface texture. In another alternative, a protective layer can be applied to the decorative surface texture to protect or enhance the surface texture. In another alternative, visible or fluorescent dyes can be added to the photopolymer.

The methods and materials disclosed herein are not exclusive and can be expanded upon and modified by the person of skill in the art. For example, substrates that are opaque to certain wavelengths of light that are not used to activate and cure the photopolymer may be used. In another modification, the flowable photopolymer can be applied first to the substrate and then the substrate can be applied—photopolymer material layer down—against the three-dimensional decorated surface of the metal sheet mold. Moreover, the upwards orientation of the various decorative part components shown in FIGS. 1A through 2F may not be necessary and, where appropriate can be changed. In yet another modification, the mold can be a block, it can be bendable or three-dimensional in shape or the mold can double as the substrate.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for manufacturing a decorated polycarbonate sheet, comprising:
providing a mold having a surface and a three-dimensional pattern formed on the surface, such that the three-dimensional pattern resembles a machined metal surface;
contacting the three-dimensional pattern of the mold and a curable photopolymer with one another;
placing a substrate into contact with the curable photopolymer such that the curable photopolymer forms a curable layup at least partially between the substrate and the mold;
curing the curable layup to form a cured layup; and
separating the mold from the cured layup;
wherein the cured layup has a decorative surface texture corresponding with the three-dimensional pattern of the mold, such that the decorative surface texture mirrors the three-dimensional pattern resembling the machined metal surface.

2. The method of claim 1 further comprising compressing the curable layup between the substrate and the mold so as to remove at least a portion of air within the curable layup.

3. The method of claim 1 wherein the step of curing the curable layup is further defined by exposing the curable layup to ultraviolet light.

4. The method of claim 1 wherein the three-dimensional pattern resembles a plurality of swirls that are arranged adjacent to one another, and the step of applying the curable photopolymer onto the three-dimensional pattern of the mold is further defined by forming the decorative surface texture such that the decorative surface texture mirrors the plurality of swirls adjacent to one another.

5. The method of claim 6 wherein the plurality of swirls are arranged in a plurality of columns along the surface of the mold, and the step of applying the curable photopolymer onto the three-dimensional pattern of the mold is further defined by forming the decorative surface texture such that the decorative surface texture mirrors the plurality of swirls arranged in the plurality of columns.

6. The method of claim 1 further comprising forming the substrate of the cured layup by applying at least one of heat and pressure to the substrate.

7. The method of claim 1 wherein the substrate comprises a material that is transparent to light having a wavelength configured to cure the curable layup, and the step of curing the curable layup is further defined by directing the light through the substrate and at the curable layup.

8. The method of claim 1 wherein the mold comprises a material that is transparent to light having a wavelength configured to cure the curable layup, and the step of curing the curable layup is further defined by directing the light through the mold and at the curable layup.

9. A system for manufacturing a decorated polycarbonate sheet, comprising:
a mold having a surface and a three-dimensional pattern that is formed on the surface, such that the three-dimensional pattern resembles a machined metal surface;
a substrate configured to contact a curable photopolymer, such that the curable photopolymer forms a curable layup between the substrate and the mold; and
a light source configured to cure the curable layup so as to form a cured layup;
wherein the mold is configured to be separated from the cured layup;
wherein the cured layup has a decorative surface texture corresponding with the three-dimensional pattern of the mold, such that the decorative surface finish mirrors the three-dimensional pattern resembling the machined metal surface.

10. The system of claim 9 further comprising a roller mechanism configured to apply a force to the substrate so as to compress the curable layup between the substrate and the mold.

11. The system of claim 9 wherein the substrate is comprised of a material that is transparent to light having a wavelength configured to cure the curable layup, such that the curable layup is cured by directing the light through the substrate and at the curable layup.

12. The system of claim 9 wherein the substrate is comprised of at least one of glass, a polymer and a polycarbonate sheet.

13. The system of claim 9 wherein the mold is comprised of a material that is opaque to light having a wavelength not configured to cure the curable layup.

14. The system of claim 9 wherein the mold is comprised of at least one of nickel, copper, aluminum, stainless steel, zinc and an alloy.

15. The system of claim 9 wherein the substrate is comprised of a material that is opaque to light having a wavelength not configured to cure the curable layup.

16. The system of claim 9 wherein the substrate is comprised of at least one of nickel, copper, aluminum, stainless steel, zinc and an alloy.

17. The system of claim 9 wherein the mold is comprised of a material that is transparent to light having a wavelength configured to cure the curable layup, and the curable layup is cured by directing the light through the curable layup and at the curable layup.

18. The system of claim 9 wherein the mold is comprised of at least one of glass and a polymer, and a polycarbonate.

19. A decorated polycarbonate sheet, comprising:
a substrate; and
a cured layup formed from a curable photopolymer and having a decorative surface texture corresponding with a three-dimensional pattern of a mold;
wherein the three-dimensional pattern of the mold resembles a machined metal surface, such that the decorative surface texture of the cured layup mirrors the three-dimensional pattern resembling the machined metal surface.

20. The decorated polycarbonate sheet of claim 19, wherein the sheet is formed by the process of:
contacting the three-dimensional pattern of the mold and a curable photopolymer with one another;
placing the substrate into contact with the curable photopolymer, such that the curable photopolymer forms a curable layup at least partially between the substrate and the mold;
curing the curable layup to form the cured layup; and
separating the mold from the cured layup.
